(19) United States
(12) Patent Application Publication
(10) Pub. No.: US 2016/0093181 A1
(43) Pub. Date: Mar. 31, 2016

(54) METHOD AND APPARATUS FOR GENERATING A SUPER-RESOLVED IMAGE FROM MULTIPLE UNSYNCHRONIZED CAMERAS

(71) Applicant: MOTOROLA SOLUTIONS, INC, SCHAUMBURG, IL (US)

(72) Inventors: KUAN HENG LEE, AIR ITAM (MY); VIKAS BHAT, SCHAUMBURG, IL (US); KEVIN J. O'CONNELL, PALATINE, IL (US); MOH LIM SIM, BAYAN LEPAS (MY); YAN ZHANG, BUFFALO GROVE, IL (US)

(21) Appl. No.: 14/497,558

(22) Filed: Sep. 26, 2014

(51) Int. Cl. G08B 13/196; G06K 9/00; G06T 5/50; H04N 7/18

(52) U.S. Cl. CPC G08B 13/19641; H04N 7/181; G08B 13/19608; G06K 9/00221; G06T 5/50

(57) ABSTRACT

A method and apparatus for generating a super-resolved image from multiple unsynchronized cameras are provided herein. During operation logic circuitry will receive multiple images from multiple unsynchronized cameras. The logic circuitry will determine a viewshed for each image by extracting time and location information from each received image. Images sharing a similar viewshed will be used to generate a super-resolved image.

### FIELD OF THE INVENTION

The present invention generally relates to generating a super-resolved image, and more particularly to using a super-resolution technique to generate a super-resolved image by using multiple unsynchronized cameras.

### BACKGROUND OF THE INVENTION

The process of facial recognition is one of the most widely used video-analysis and image-analysis techniques employed today. In the public-safety context, a vast amount of visual data is obtained on a regular and indeed often substantially continuous basis. Oftentimes one would wish to identify, e.g., a person of interest in these images and recordings. It could be the case that the quick and accurate identification of said person of interest is of paramount importance to the safety of the public, whether in an airport, a train station, a high-traffic outdoor space, or some other location. Among other benefits, facial recognition can enable public-safety responders to identify persons of interest promptly and correctly. It is often the case, however, that the quality of the images being input to—and analyzed by—facial-recognition software is correlated with the accuracy and immediacy of the results. Poor image quality may be due to one or more of low resolution, indirect view of a person's face, less-than-ideal lighting conditions, and the like.

One technique to compensate for poor image quality is to use a super-resolution technique to improve image quality. For an example of this technique, see David L. McCubbrey's U.S. Pat. No. 8,587,661, entitled SCALABLE SYSTEM FOR WIDE AREA SURVEILLANCE, incorporated by reference herein. The '661 patent describes super resolution using multiple cameras to aide in, for example, facial recognition. Faces from multiple cameras are time synchronized (face synchronization), like faces from the multiple cameras are grouped (face correlation), and then finally a collaborative super-resolution technique is used to generate super-resolved image for detected faces.

A drawback in the '661 patent is that when performing face synchronization, the '661 patent relies on synchronized cameras sharing a common time signal to ensure that faces are acquired by the different cameras at a same point in time and space. This requires a synchronization signal to be provided to each camera. Not only is this process of synchronizing cameras complex, but images from unsynchronized cameras cannot be used to compute any super-resolved image. Therefore, a need exists for a method and apparatus for generating a super-resolved image using multiple unsynchronized cameras.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 shows a general operational environment for practicing the present invention.

FIG. 2 is a flow chart showing operation of the device of FIG. 1.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the above, mentioned need, a method and apparatus for generating a super-resolved image from multiple unsynchronized cameras are provided herein. During operation logic circuitry will receive multiple images from multiple unsynchronized cameras. The logic circuitry will determine a viewshed for each image by extracting time and location information from each received image. Images sharing a similar viewshed will be used to generate a super-resolved image.

It should be noted that the term unsynchronized denotes the fact that some of the cameras used in generating the super-resolved image do not share a common time source/signal. Therefore, at least two cameras used will use different sources (e.g., internal clocks with no common sync signal) to determine a time when an image is taken.

The image viewshed is based on a time the image was acquired and camera field of view/vision (FOV). The FOV is determined from location information of the camera when the image was acquired, such that

viewshed=F(time, FOV), where,

FOV=F(camera location information).

The time and location information is preferably provided by a camera along with an image. A camera FOV may comprise a camera's location and its pointing direction, for example, a GPS location and a compass heading. Based on this information, a FOV can be determined. For example, a current location of a camera may be determined from an image (e.g., 42 deg 04′ 03.482343″ lat., 88 deg 03′ 10.443453″ long. 727 feet above sea level), and a compass bearing matching the camera's pointing direction may be determined from the image (e,g, 270 deg. from North), a level direction of the camera may be determined from the image (e.g., −25 deg. from level), and a magnification (zoom) may be determined (e.g., 10×) from the image. From the above information, the camera's FOV is determined by determining a geographic area captured by the camera having objects above a certain dimension resolved. For example a FOV may comprise any geometric shape that has, for example, objects greater than 1 cm resolved (occupying more than 1 pixel).

In an alternate embodiment of the present invention the FOV may be determined from the pictorial background within the image itself. For example the FOV may be classified in terms an average brightness, an average color, an average texture, or a type clothing worn by a person. In other words, in the alternate embodiment,

FOV=F(image).

In order to increase an accuracy of determining a FOV, the first and second embodiments may be combines such that:

FOV=F(camera location information, image).

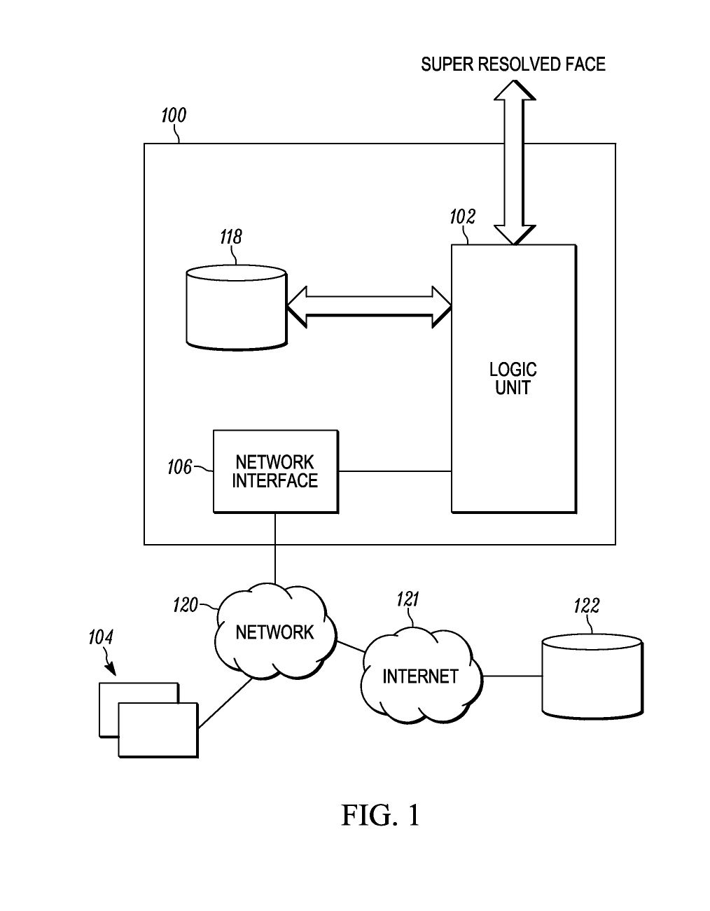

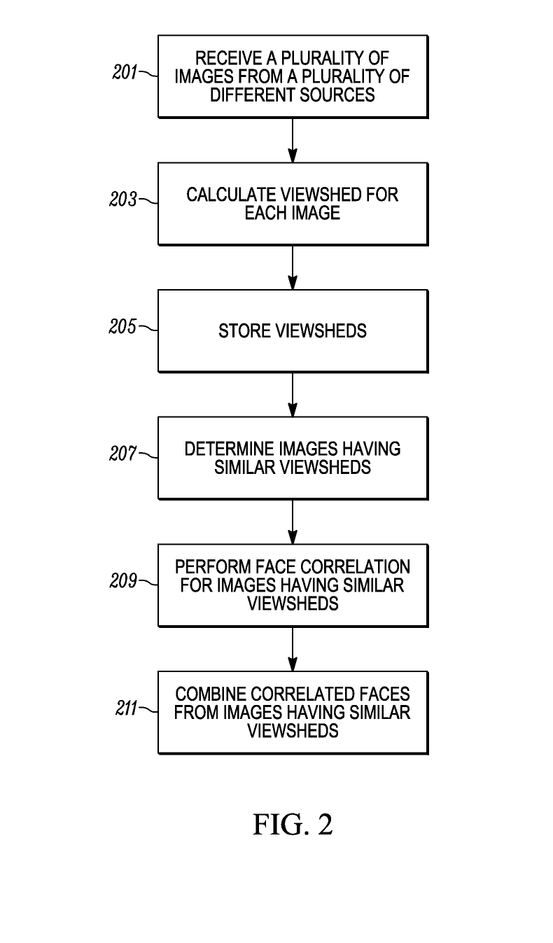

FIG. 1 is a block diagram illustrating a general operational environment detailing super-resolution device 100 according to one embodiment of the present invention. In general, as used herein, the super-resolution device 100 being “configured” or “adapted” means that the device 100 is implemented using one or more components (such as memory components, network interfaces, and central processing units) that are operatively coupled, and which, when programmed, form the means for these system elements to implement their desired functionality, for example, as illustrated by reference to the methods shown in FIG. 2.

In the current implementation, super-resolution device 100 is adapted to compute a super-resolved face from multiple cameras (some of which are unsynchronized) and provide the super-resolved face to, for example, facial recognition circuitry (not shown in FIG. 1). However it should be understood that various embodiments may exist where the super-resolved image is used for things other than facial recognition.

Super-resolution device 100 comprises processor or logic unit 102 that is communicatively coupled with various system components, including a network interface 106 and a general storage component 118. Only a limited number of system elements are shown for ease of illustration; but additional such elements may be included in the super-resolution device 100. The functionality of the super resolution device 100 may be embodied in various physical system elements, including a standalone device, or as functionality in a Network Video Recording device (NVR), a Physical Security Information Management (PSIM) device, a camera 104.

The processing device (logic unit) 102 may be partially implemented in hardware and, thereby, programmed with software or firmware logic (e.g., super resolution program) adapted to perform the functionality described in FIG. 2; and/or the processing device 102 may be completely implemented in hardware, for example, as a state machine or ASIC (application specific integrated circuit). Storage 118 is adapted to provide short-term and/or long-term storage of various information needed for the functioning of the respective elements. Storage 118 may further store software or firmware (e.g., super resolution software and/or facial recognition software) for programming the processing device 102 with the logic or code needed to perform its functionality.

In the illustrative embodiment, one or more cameras 104 are attached (i.e., connected) to super-resolution device 100 through network 120 via network interface 106. Database 122, storing images, may also be attached to device 100 through multiple intervening networks. Example networks 120 include any combination of wired and wireless networks, such as Ethernet, T1, Fiber, USB, IEEE 802.11, 3GPP LTE, and the like. Network interface 106 connects processing device 102 to the network 120. Where necessary, network interface 106 is adapted to provide the necessary processing, modulating, and transceiver elements that are operable in accordance with any one or more standard or proprietary wireless interfaces, wherein some of the functionality of the processing, modulating, and transceiver elements may be performed by means of the processing device 102 through programmed logic such as software applications or firmware stored on the storage component 118 or through hardware.

During operation, processing device 102 receives images from multiple cameras 104, all of which may be unsynchronized (for simplicity, only two cameras 104 are shown in FIG. 1, although in actuality, an unlimited number (e.g., millions) of cameras may be utilized since they do not need to be synchronized. Along with image data, each camera image comprises a time when the video/image was acquired, a camera's geographic location, and optionally, a pointing direction (N, S, E, W, degrees from north, . . . , etc.). Logic unit 102 then calculates an image viewshed for each received camera feed, where as described above viewshed=F(time, FOV) and stores this information in storage 118.

It should also be noted that images used to provide a super-resolved face may comprise any acquired image, whether live or from storage 122. As long as a viewshed can be calculated for an image, the image may come from any source. For example, images may be pulled through the internet 121 from, for example, social media sources. Therefore, as long as two images share a similar viewshed (e.g., within a predetermined time (e.g., 1 minute) and within a predetermined location (e.g., 10 feet)) they can be utilized to provide a super-resolved image.

FIG. 2 is a flow chart showing operation of device 100. The logic flow begins at step 201 where logic unit 102 receives a plurality of images from a plurality of different sources. As discussed above, in a first embodiment the plurality of images each have an associated timestamp of when the image was acquired, and a location as to where the image was acquired. In some embodiments, the images also have an associated direction as to the direction the camera was pointing when the image was acquired. In some embodiments of the present inventions, some, if not all images may also be provided with their viewshed.

At step 203 logic unit 102 calculates a viewshed for each received image. As discussed above, viewshed=F(time, FOV). Thus, the viewshed for a particular image comprises information regarding a field of view visible within the image along with a time in which the image was captured.

A map (not shown in FIG. 1) may be provided to logic unit 102 and used to determine obstructions such as buildings, bridges, hills, etc. that may obstruct the camera's view. As described above, in one embodiment, a location for a particular camera is determined along with a pointing direction (135 degrees from North) and FOV for the camera is determined based on the geographic location and pointing direction. In a second embodiment of the present invention background information within the image itself is used to determine a FOV. Finally, in a third embodiment of the present invention, both of the techniques are combined. Regardless of how the viewshed is generated for each image, the viewshed is stored in storage 118 (step 205).

At step 207 logic unit determines all images having a similar viewshed. More particularly, logic unit 102 determines all images having a viewshed that at least partially overlaps, or alternatively, is within a predetermined distance/time from each other. Alternatively, logic unit 102 may determine images having a similar pictorial background (e.g., similar average color, texture, brightness . . . , etc.).

At step 209 a face correlation procedure takes place by logic unit 102. More particularly, similar faces among those images with similar viewsheds are determined. For example, logic unit 102 considers the appearance of the person (such as attributes on gender, hair color, eyewear, moustache, eyes, mouth, nose, forehead, etc.) Correlated faces from images having similar viewsheds are combined via a super-resolution technique to provide super-resolved faces (step 211). This may be accomplished as described in the '661 patent, or alternatively by using any other super-resolution technique.

The above technique provides for a method for generating a super-resolved image. During operation logic unit 102 will receive a plurality of images from a plurality of unsynchronized sources, calculate viewsheds for each received image, determine images having similar viewsheds, determine a group of similar faces within the images having similar viewsheds, and generating a super-resolved image from the similar faces within the images having similar viewsheds.

As discussed above, the received images may comprise the step of receiving images over the internet through social media, receiving the images from a plurality of unsynchronized cameras, or a combination of both.

Additionally, the viewsheds may be calculated based on a time and a field of view/vision (FOV), wherein the FOV can be based on camera location information or pictorial background information within the image. The background information may comprise information from the group consisting of an average brightness, an average color, an average texture, and a type clothing worn by a person. The step of determining the group of similar faces within the images having similar viewsheds may comprise the step of determining faces having similar attributes such as from the group consisting of gender, hair color, eyewear, moustache, eyes, mouth, nose, and forehead.

Finally, the step of generating the super-resolved image may comprise the step of combining faces having the similar attributes from images having similar viewsheds.

An apparatus is also provided. The apparatus comprises logic circuitry receiving a plurality of images from a plurality of unsynchronized sources, calculating viewsheds for each received image, determining images having similar viewsheds, determining a group of similar faces within the images having similar viewsheds, and generating a super-resolved image from the similar faces within the images having similar viewsheds.

As discussed, the plurality of images can be received over an internet through social media, received from a plurality of unsynchronized cameras, or a combination of both. The viewsheds are based on a time and a field of view/vision (FOV), wherein the FOV can be based on camera location information, based on pictorial background information within the image, or a combination of both. The background information may comprise information from the group consisting of an average brightness, an average color, an average texture, and a type clothing worn by a person.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for generating a super-resolved image, the method comprising the steps of:
receiving a plurality of images from a plurality of unsynchronized sources;
calculating viewsheds for each received image;
determining images having similar viewsheds;
determining a group of similar faces within the images having similar viewsheds;
generating a super-resolved image from the similar faces within the images having similar viewsheds.

2. The method of claim 1 wherein the step of receiving the plurality of images comprises the step of receiving images over the internet through social media.

3. The method of claim 1 wherein the step of receiving the plurality of images comprises the step of receiving the plurality of images from a plurality of unsynchronized cameras.

4. The method of claim 1 wherein the step of receiving the plurality of images comprises the step of receiving the plurality of images from a plurality of unsynchronized cameras and over the internet through social media.

5. The method of claim 1 wherein the step of calculating the viewsheds comprises the step of calculating the viewsheds based on a time and a field of view/vision (FOV), wherein the FOV is based on camera location information.

6. The method of claim 1 wherein the step of calculating the viewsheds comprises the step of calculating the viewsheds based on a time and a field of view/vision (FOV), wherein the FOV is based on pictorial background information within the image.

7. The method of claim 6 wherein the background information comprises information from the group consisting of an average brightness, an average color, an average texture, and a type clothing worn by a person.

8. The method of claim 1 wherein the step of determining the group of similar faces within the images having similar viewsheds comprises the step of determining faces having similar attributes.

9. The method of claim 8 wherein the similar attributes are taken from the group consisting of gender, hair color, eyewear, moustache, eyes, mouth, nose, and forehead.

10. The method of claim 8 wherein the step of generating the super-resolved image comprises the step of combining faces having the similar attributes from images having similar viewsheds.

11. An apparatus comprising:
logic circuitry receiving a plurality of images from a plurality of unsynchronized sources, calculating viewsheds for each received image, determining images having similar viewsheds, determining a group of similar faces within the images having similar viewsheds, and generating a super-resolved image from the similar faces within the images having similar viewsheds.

12. The apparatus of claim 11 wherein the plurality of images are received over an internet through social media.

13. The apparatus of claim 11 wherein the images are received from a plurality of unsynchronized cameras.

14. The apparatus of claim 11 wherein the images are received from a plurality of unsynchronized cameras and over the internet through social media.

15. The apparatus of claim 11 wherein the viewsheds are based on a time and a field of view/vision (FOV), wherein the FOV is based on camera location information.

16. The apparatus of claim 11 wherein the viewsheds are based on a time and a field of view/vision (FOV), wherein the FOV is based on pictorial background information within the image.

17. The apparatus of claim 16 wherein the background information comprises information from the group consisting of an average brightness, an average color, an average texture, and a type clothing worn by a person.

18. The apparatus of claim 11 wherein the similar faces within the images have similar viewsheds and similar attributes.

19. The apparatus of claim 18 wherein the similar attributes are taken from the group consisting of gender, hair color, eyewear, moustache, eyes, mouth, nose, and forehead.

20. The apparatus of claim 18 wherein the super-resolved image is generated by combining faces having the similar attributes from images having similar viewsheds.
